(19) United States
(12) Patent Application Publication
(10) Pub. No.: US 2015/0296417 A1
(43) Pub. Date: Oct. 15, 2015

(54) BASE STATION AND TERMINAL

(71) Applicant: SHARP KABUSHIKI KAISHA, Osaka-shi, Osaka (JP)

(72) Inventors: Kozue Yokomakura, Osaka-shi (JP); Takashi Yoshimoto, Osaka-shi (JP); Ryota Yamada, Osaka-shi (JP); Katsuya Kato, Osaka-shi (JP)

(73) Assignee: Sharp Kabushiki Kaisha, Osaka-shi, Osaka (JP)

(21) Appl. No.: 14/438,943

(22) PCT Filed: Oct. 31, 2013
(86) PCT No.: PCT/JP2013/079606

§ 371 Date: Apr. 28, 2015

(30) Foreign Application Priority Data
Nov. 1, 2012 (JP) 2012-241503

(51) Int. Cl. H04W 36/00; H04W 36/30

(52) U.S. Cl. CPC H04W 36/0011; H04W 36/30

(57) ABSTRACT

In a communication system that includes a first base station, a second base station, and at least one terminal that makes a connection to the second base station, a connection destination of the terminal that makes a connection to the second base station is efficiently switched. The terminal that makes a connection to the second base station determines received quality of each of a neighboring base station that is positioned in the neighborhood of the second base station and the second base station, and notifies a macro cell base station and the second base station of the received quality. Furthermore, the first base station or the second base station determines whether or not the terminal has to perform handover, based on the received quality. In a case where the handover has to be performed, the first base station determines the connection destination of the terminal, based on the received quality notified from the terminal, and provides a handover instruction.

### TECHNICAL FIELD

The present invention relates to a base station and a terminal.

This application claims priority of Japanese Patent Application No. 2012-241503 filed Nov. 1, 2012, the entire contents of which are incorporated herein by reference.

### BACKGROUND ART

In a radio communication system such as a mobile phone, multiple base stations (evolved Node Bs (eNBs)) are arranged to cover a wide area, and each base station makes a connection to a terminal (user equipment (UE)). Thus, data communication is performed and the connection is managed. A range (a communication area) in which it is possible for each base station to make a connection to the terminal is referred to as a cell and several areas into which the cell is divided are referred to as sectors. Each base station manages connection to a terminal, with the cell or the sector as units.

In recent years, with an increase in an amount of traffic due to the spread of smartphones and the like, further distribution of traffic is needed. Thus, in the 3rd Generation Partnership Project (3GPP), it has been proposed that cells (which include a pico cell, a femto cell, a small cell, and the like, and are hereinafter referred to as small cells) that are serviced by low-power base stations (Low Power Node (LPN), a pico cell base station, a femto cell base station, and the like) should be arranged within a cell (which is, for example, a macro cell, and is hereinafter referred to as a macro cell) of which the communication area is a wide area with a large cell radius (NPL 1). At this point, the low-power base station means a base station that has lower transmission power than the macro cell base station.

### CITATION LIST

### Non Patent Literature

NPL 1: Ericsson, RWS-120003, Views on Rel-12, June, 2012.

### SUMMARY OF INVENTION

### Technical Problem

In NPL 1, it is disclosed that multiple small cells are arranged within a macro cell, but for example, specific means of realization relating to handover that the terminal that makes a connection to the low power base station performs, such as a procedure in a case where the terminal that makes a connection to the low-power base station changes a connection to a different base station, or a method of determining a new connection destination, is not disclosed. At this point, the handover, which accompanies an inter-cell movement of the terminal, and the like, is for the terminal to switch the base station to which the terminal makes a connection.

Furthermore, when a handover method that is used in a current cellular system is applied, the low-lower base station needs to determine a new connection destination and use a procedure for the handover. For this reason, the low-power base station is a high-performance base station like the macro cell base station, and an amount of processing by the low-power base station is increased. This leads to enlargement of the low-power base station or a cost increase, and makes it difficult to arrange multiple low-power base stations within a macro cell.

The present invention, which is made in view of the problems described above, is to provide a base station and a terminal that are capable of decreasing an amount of processing by a low-power base station and of efficiently switching a connection destination.

### Solution to Problem

To deal with these problems, each configuration of a base station and a terminal according to the present invention is as follows.

(1) According to an aspect of the present invention, there is provided a first base station in a communication system that includes the first base station, a second base station, and at least one terminal that makes a connection to the second base station, in which information that relates to received quality of the terminal with respect to each of the second base station and a neighboring base station that is positioned in the neighborhood of the second base station is received from the terminal.

(2) In the described-above first base station according to the aspect of the present invention, a configuration may be provided in which, in a case where a first handover request for changing a connection destination of the terminal is present, based on the received quality, a third base station that is a new connection destination of the terminal is determined.

(3) In the described-above first base station according to the aspect of the present invention, a configuration may be provided in which the first handover request is made based on the received quality.

(4) In the described-above first base station according to the aspect of the present invention, the first handover request may be notified from the second base station.

(5) In the described-above first base station according to the aspect of the present invention, the first handover request may be a first handover inquiry that includes information needed for changing the connection destination of the terminal.

(6) In the described-above first base station according to the aspect of the present invention, a configuration may be provided in which the third base station is notified of a second handover request for a connection by the terminal.

(7) In the described-above first base station according to the aspect of the present invention, a configuration may be provided in which a response to the second handover request is received from the third base station.

(8) In the described-above first base station according to the aspect of the present invention, a configuration may be provided in which, in a case where the response to the second handover request is an ACK, the terminal is instructed to make a connection to the third base station, and the terminal is notified of target base station information that is information on the third base station.

(9) In the described-above first base station according to the aspect of the present invention, a configuration may be provided in which, in the case where the response to the second handover request is an ACK, the second base station is instructed to allow the terminal to make a connection to the third base station.

(10) In the described-above first base station according to the aspect of the present invention, the second handover request may be a second handover inquiry that includes information needed for the connection by the terminal.

(11) According to another aspect of the present invention, there is provided a second base station in a communication system that includes a first base station, the second base station, and at least one terminal that makes a connection to the second base station, in which it is determined whether or not a connection destination of the terminal has to be changed, and in a case where it is determined that the connection destination has to be changed, the first base station is notified of a first handover request.

(12) In the described-above second base station according to the aspect of the present invention, a configuration may be provided in which the second base station receives a notification that the terminal makes a connection to the third base station from the first base station, notifies the terminal of an instruction to make a connection to the third base station, and notifies the terminal of information on the third base station.

(13) In the described-above second base station according to the aspect of the present invention, the first handover request may be a first handover inquiry that includes information needed for changing the connection destination of the terminal.

(14) According to a further aspect of the present invention, there is provided a terminal in a communication system that includes a first base station, a second base station, and at least one terminal that makes a connection to the second base station, in which the first base station is notified of information relating to received quality of the terminal with respect to each of the second base station and a neighboring base station that is positioned in the neighborhood of the second base station.

(15) In the described-above terminal according to the aspect of the present invention, a configuration may be provided in which information on a third base station that is a new connection destination is received from at least one of the first base station and the second base station, and communication with the third base station is started using the information on the third base station.

### Advantageous Effects of Invention

According to the aspects of the present invention, in a case wherein a connection destination of the terminal that makes a connection to a low power base station is changed, an amount of processing by the low power base station can be decreased and the connection destination can be efficiently switched.

### BRIEF DESCRIPTION OF DRAWINGS

FIG. 1 is a schematic diagram illustrating a configuration example of a communication system according to a first embodiment.

FIG. 2 is a schematic diagram illustrating a configuration example of a communication system in which a macro cell base station 100 manages a connection to a terminal 300 as a unit of a sector.

FIG. 3 is a sequence diagram illustrating one example of a flow of processing operations that is performed by the communication system according to the first embodiment.

FIG. 4 is a schematic block diagram illustrating a configuration example of the macro cell base station 100 according to the first embodiment.

FIG. 5 is a schematic block diagram illustrating a configuration example of a low-power base station 200-x according to the first embodiment.

FIG. 6 is a schematic block diagram illustrating a configuration example of a terminal 300 according to the first embodiment.

FIG. 7 is a sequence diagram illustrating one example of a flow of processing operations that are performed by a communication system according to the second embodiment.

FIG. 8 is a schematic block diagram illustrating a configuration example of a macro cell base station 100 according to the second embodiment.

FIG. 9 is a sequence diagram illustrating one example of a flow of processing operations that are performed by a communication system according to a third embodiment.

FIG. 10 is a schematic block diagram illustrating a configuration example of a macro cell base station 100 according to the third embodiment.

FIG. 11 is a schematic block diagram illustrating a configuration example of a low-power base station 200-x according to the third embodiment.

FIG. 12 is a sequence diagram illustrating one example of a flow of processing operations that are performed by a communication system according to a fourth embodiment.

FIG. 13 is a schematic block diagram illustrating a configuration example of a macro cell base station 100 according to the fourth embodiment.

### DESCRIPTION OF EMBODIMENTS

Embodiments of the present invention will be described in detail below referring to the drawings.

### First Embodiment

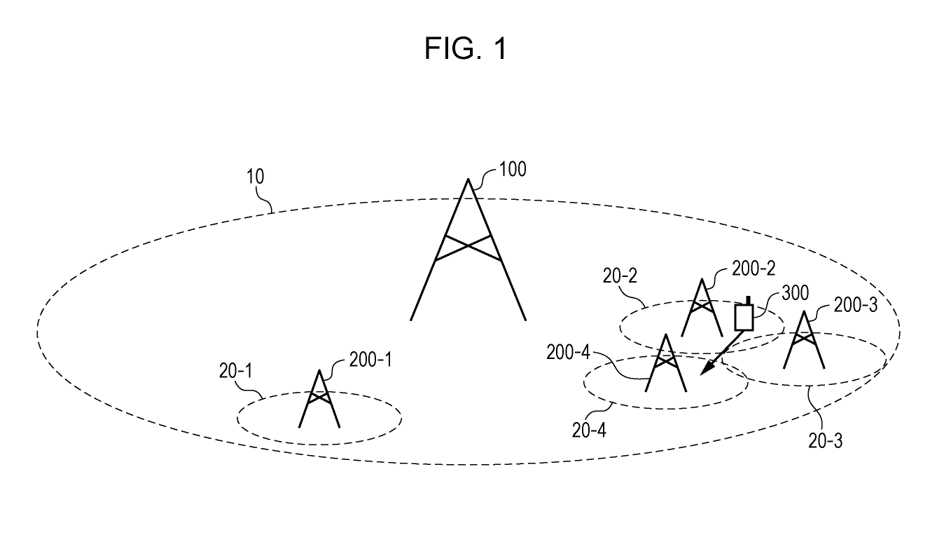

FIG. 1 is a schematic diagram illustrating a configuration example of a communication system according to the first embodiment. As illustrated in FIG. 1, the communication system according to the present embodiment is configured from small cells 20-x, a communication area of each of which is set to be an area that is serviced by low-power base stations 200-x, within a macro cell 10 (a macro area), a communication area of which is a broad area that is serviced by a macro cell base station 100 (a first base station). At this point, x is an arbitrary positive integer, and in an example according to the present embodiment, is set to be 1×4. Furthermore, in FIG. 1, a terminal 300 is assumed to make a connection to a low-power base station 200-2 and then move toward a low-power base station 200-4. Moreover, according to the present embodiment, the terminal 300 may make a connection to any one of the low-power base stations 200-x and be present at an arbitrary position within a macro area.

According to the following embodiments, a method is described in which a macro cell base station manages the connection by the terminal and in which handover that is performed by a terminal that makes a connection to a low-power base station is assisted. However, the macro cell base station and the low-power base station may be distinguished from each other not only by transmission power, but also depending on whether the cell that is serviced by the base station is a backward-compatible cell that supports a scheme that is already in service or is a non-backward-compatible cell that is newly defined.

Moreover, as is the case with a pico cell base station and a femto cell base station, in some cases, even base stations that are included in a small cell have different transmission power or a different communication area from one another, but in such situations, the present invention can be applied. Furthermore, the connection to the macro cell base station and the low-power base station is made with a backhaul line, may be made in a wired manner, such as when using an optical fiber or an X2 interface, and may be made in the same wireless manner as with a relay base station.

According to the present embodiment, the communication system in FIG. 1 is assumed to be one example, but the present embodiment can be applied to any communication system that is configured from at least one small cell within a macro cell. The present embodiment is not limited in the number of cells, the number of base stations, the number of terminals, a type of cell (for example, a pico cell, a femto cell, and the like), a type of base station, and the like.

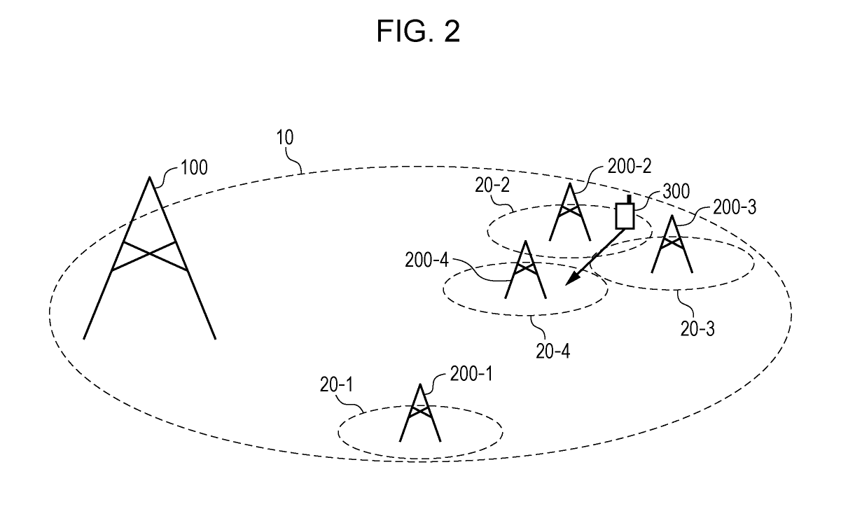

Furthermore, the macro cell base station 100 may be a communication system that manages a connection to the terminal 300 as a unit of a sector. FIG. 2 is a schematic diagram illustrating a configuration example of the communication system in which the macro cell base station 100 manages the connection to the terminal 300 as a unit of a sector. As illustrated in FIG. 2, a macro cell 10 is configured from sectors in one direction of the macro cell base station 100, and at least one small cell 20-x is arranged within the macro cell 10. In this respect, the first embodiment and other embodiments are the same. Furthermore, in FIGS. 1 and 2, small cells completely overlap one another within a macro cell, but may partially overlap one another and may not overlap one another. However, the present invention is not limited to this.

According to the present embodiment, the base stations (the macro cell base station 100 and the low-power base station 200-x) in each cell periodically transmit a synchronization signal (SS), a tracking signal, and a measurement signal. At this point, the synchronization signal, for example, is a signal for searching (cell-searching) for a carrier frequency, such as a primary SS (PSS) or a secondary SS (SSS), or a cell ID, which is defined in the Third Generation Partnership Project (3GPP). The tracking signal is a signal for identifying a sample point of a received signal more exactly than with the synchronization signal. The measurement signal is a signal for measuring a received quality, and is a cell-specific reference signal, a shared pilot signal, or the like. Furthermore, in the 3GPP, reference signal received power (RSRP) can be used in order to measure the received quality. Moreover, all the base stations do not necessarily need to transmit all of these signals. For example, a method may be employed in which only some of the signals are transmitted, such as a method in which only the tracking signal and the measurement signal are transmitted. A signal format of each signal may be changed. Furthermore, synchronization methods that are different in the macro cell base station 100 and the low-power base station 200-x may be used, for example, such as when the macro cell base station uses a method that maintains backward compatibility and the low-power base station uses a new method (which, for example, is referred to as a new carrier type (NCT) in the 3GPP). Therefore, for example, the macro cell base station 100 is available for a signal format that is included in all the signals, but the low-power base station 200-x can be set to be available for a signal format that is included only in the tracking signal and the measurement signal. Furthermore, the tracking signal and the measurement signal may be the same signal, and the tracking signal and the measurement signal are described below as being in the same signal format. Furthermore, different frequencies in the macro cell base station and the low-power base station are hereinafter assumed to be used, but there is no limitation to this assumption.

Moreover, according to the embodiment of the present invention, the search for the carrier frequency and the search for the cell ID are defined as a cell search, and the identification of the sample point is defined as synchronization. However, if the similar processing operations are performed, they are substantially the same.

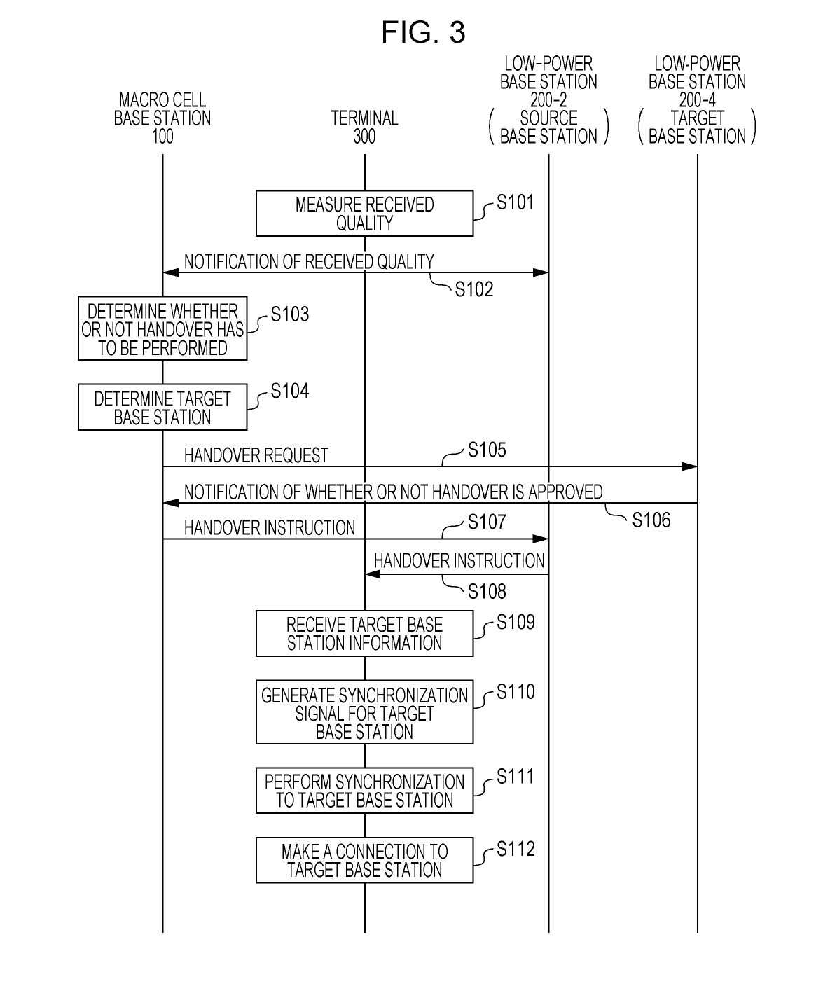

First, a flow of processing operations according to the present embodiment is described. FIG. 3 is a sequence diagram illustrating one example of the flow of processing operations that are performed by the communication system according to the first embodiment. In FIG. 3, a source base station (also referred to as a second base station or a serving cell) indicates the low-power base station to which the terminal makes a connection before performing the handover, and is a low-power base station 200-2 according to the present embodiment. Furthermore, a target base station (also referred to as a third base station) indicates the base station to which the terminal makes a connection after performing the handover, and is a low-power base station 200-4 according to the present embodiment. Moreover, a case where a specific base station manages connections of the terminal to multiple different base stations is also included in the present invention.

The terminal 300 receives a measurement signal that is transmitted from a neighboring base station and the low-power base station 200-2, and measures received quality of each of the neighboring base station and the low-power base station 200-2 from the measurement signal (Step S101). At this point, the neighboring base station indicates a base station that is positioned in the neighborhood of the source base station, and for example, the macro cell base station may determine the neighboring base station from a cell arrangement and the like, and may indicate to the terminal 300 which a base station is the neighboring base station, in advance. Furthermore, if the received quality indicates received quality of an air link between the base station and the terminal 300 such as received power, or received Signal to Interference plus Noise power Ratio (SINR), this may be satisfactory, and it is desirable that the received quality is received quality observed over a period of time.

The terminal 300 notifies the macro cell base station 100 and the low-power base station 200-2 of the received quality of each of the neighboring base station and the low-power base station 200-2 (Step S102). Moreover, in S102 according to the present embodiment, the terminal 300 may notify the macro cell base station of the received quality of each of the neighboring base station and the low-power base station 200-2, may notify the low-power base station 200-2 of only the received quality of the base station (the low-power base station 200-2) to which the terminal 300 itself makes a connection and may notify the neighboring base station of the received quality of the neighboring base station. Furthermore, according to the present embodiment, the terminal 300 may periodically perform the measurement of and the notification of the received quality, but the notification of the received quality may be performed only in a case where the received quality changes.

Based on the received quality that is notified from the terminal 300, the macro cell base station 100 determines whether or not the handover has to be performed (Step S103). In Step S103, in a case where the received quality of notified from the terminal 300 is only the received quality of the source base station, the macro cell base 100, for example, can set a threshold in advance. Furthermore, in a case where the received quality of the low-power base station 200-2 falls below the threshold, the macro cell base station 100 can determine that the terminal 300 has to perform the handover. On the other hand, in the case where the received quality of the low-power base station 200-2 exceeds the threshold, the macro cell base station 100 can determine that the terminal 300 does not have to perform the handover. Furthermore, in a case where the received quality notified from the terminal 300 is the received quality of each of the neighboring base station and the source base station, the macro cell base station 100 can compare the received quality of the neighboring base station and the received quality of the low-power base station 200-2 that are notified, and, if a base station that has better received quality than the low-power base station 200-2 is present, the macro cell base station 100 can determine that the handover has to be performed. In Step S103, in a case where the handover has to be performed, processing operations in Step 104 and later are performed. Moreover, in Step S103, in a case where it is determined that the handover has to be performed, a request for changing a connection destination of the terminal 300 is referred to as a first handover request, and the macro cell base station 100 performs the processing operation in Step S104 and later in a case where the first handover request is present and determines the target base station.

Based on the received quality notified from the terminal 300, the macro cell base station 100 determines the target base station (Step S104). It is desirable that the macro cell base station 100 compares the received quality of the neighboring base station and the received quality of the low-power base station 200-2 and the base station that has the better received quality is set to be the target base station. For example, in a case where the low-power base station 200-4 has the best received quality, the low-power base station 200-4 is set to be the target base station. Moreover, in addition to the received quality, the macro cell base station 100 may determine the target base station considering a connection situation of each base station. Furthermore, the macro cell base station 100 sets information (for example, a cell ID of the target base station) indicating the target base station to be target base station information.

The macro cell base station 100 notifies the low-power base station 200-4 of a handover request (a second handover request) through the backhaul line (Step S105). The low-power base station 200-4 determines whether or not the connection to the terminal 300 is possible, and notifies the macro cell base station 100 whether or not the handover is possible (for example, a handover request ACK/NACK), through the backhaul line (Step S106). In a case where the connection to the terminal 300 is possible, the low-power base station 200-4 performs connection preparation, such as scheduling. The macro cell base station 100 notifies the low-power base station 200-2 of the target base station information through the backhaul line and instructs the target base station to perform the handover (Step S107).

The low-power base station 200-2 notifies the terminal 300 of the target base station information, and instructs the target base station to perform the handover (Step S108).

The terminal 300 receives the target base station information notified from the low-power base station 200-2 (Step S109), and generates a synchronization signal for the target base station (Step S110). Furthermore, the terminal 300 performs synchronization with the target base station (Step 111) and make a connection to the target base station (S112).

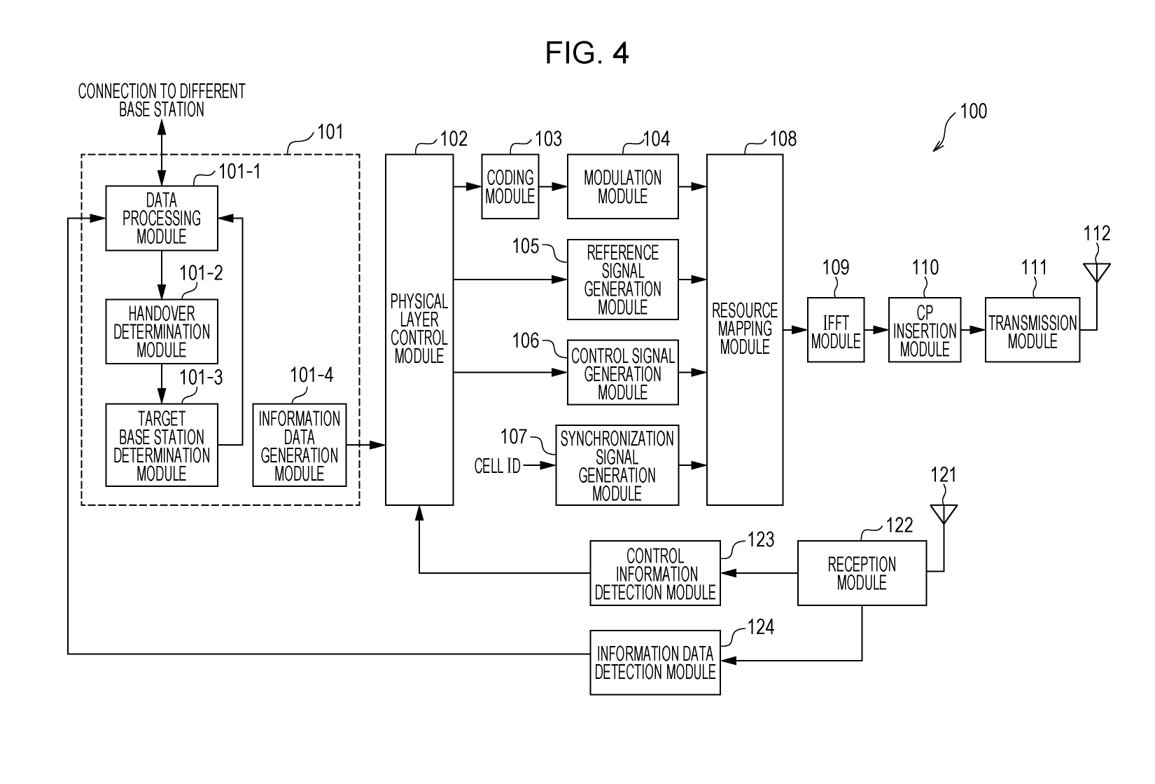

FIG. 4 is a schematic block diagram illustrating a configuration example of a macro cell base station 100 according to the first embodiment.

The macro cell base station 100 includes a data processing module 101-1, a handover determination module 101-2, a target base station determination module 101-3, an information data generation module 101-4, a physical layer control module 102, a coding module 103, a modulation module 104, a reference signal generation module 105, a control signal generation module 106, a synchronization signal generation module 107, a resource mapping module 108, an IFFT module 109, a CP insertion module 110, a transmission module 111, a transmit antenna module 112, a receive antenna module 121, a reception module 122, a control information detection module 123, and an information data detection module 124. Moreover, the data processing module 101-1, the handover determination module 101-2, the target base station determination 101-3, and the information data generation module 101-4 are referred to as a higher layer 101. Furthermore, in a case where one portion of or all portions of the macro cell base station 100 described above are integrated into an integrated circuit, a chip control circuit (not illustrated) is provided that performs control on each functional block. Moreover, in FIG. 4, the number of transmit antennas and the number of receive antennas are set to 1, but multiple antennas may be provided.

In uplink, the macro cell base station 100 receives a signal transmitted by the terminal 300 through the receive antenna module 121. At this point, the signal received by the macro cell base station 100 includes a control signal, an uplink data signal, and the like.

The control signal includes information relating to a parameter of a transmission signal that is transmitted in the downlink by the macro cell base station 100. As the information relating to the transmission signal, there are correspondingly provided a channel quality indicator (CQI), information relating to the number of ranks for MIMO transmission and the number of spatial multiplexings (a rank indicator (RI)), and other downlink scheduling. The scheduling means a determination of which frequency band the transmission is performed at, at which timing when a certain piece of data is transmitted. The scheduling information means information relating to the time and the frequency band that are determined. For example, in LTE and LTE-A, the scheduling information means a determination of which resource block information data and the like are allocated to. Moreover, the resource block is a unit for signal allocation, which is configured by collecting multiple resource elements, each of which is a minimum unit in which a signal that is configured from one subcarrier and one OFDM symbol is arranged. Moreover, the control signal is transmitted using an uplink control channel (a Physical Uplink Control Channel (PUCCH)).

The uplink data signal includes information that is needed in the higher layer 101. According to the present embodiment, the received quality is included in the uplink data signal. Moreover, the control signal from the higher layer 101 is transmitted using an uplink shared channel (a Physical Uplink Shared Channel (PUSCH)).

The reception module 122 down-converts (performs radio frequency conversion of) the received signal into a frequency band in which digital signal processing is possible such as signal detection processing and performs filtering processing. Furthermore, the signal on which the filtering processing is performed is converted from an analog signal into a digital signal (analog to digital conversion (A/D conversion)), the control signal is output to the control information detection module 123, and the uplink data signal is output to the information data detection module 124.

The control information detection module 123 performs demodulation processing and decoding processing on the control signal, which is input from the reception module 122, detects the control information, and outputs the resulting control information to the physical layer control module 102.

The information data detection module 124 performs the demodulation processing, the decoding processing, and the like on the uplink data signal, which is input from the reception module 122, detects uplink information data, and outputs the resulting uplink information data to the higher layer 101 (the data processing module 101-1).

The higher layer 101 is connected to a different base station with the backhaul line, and transmits and receives data. At this point, the higher layer is set to include a radio resource control (RRC) layer.

The data processing module 101-1 performs processing of data acquired by the higher layer 101. First, the data processing module 101-1 detects the received quality from the uplink information data, which is input from the information data detection module 124, and outputs the resulting received quality to the handover determination module 101-2.

Based on the received quality, which is input from the data processing module 101-1, the handover determination module 101-2 determines whether or not the terminal 300 has to perform the handover (Step S103 in FIG. 3). Furthermore, in a case where the handover has to be performed, the handover determination module 101-2 outputs the received quality to the target base station determination 101-3.

Based on the received quality, which is input from the handover determination module 101-2, the target base station determination module 101-3 determines the target base station (Step S104 in FIG. 3), and outputs the target base station information to the data processing module 101-1. Moreover, according to the present embodiment, the low-power base station 200-4 is set to be determined as the target base station.

Through the backhaul line, the data processing module 101-1 notifies the target base station of the handover request (Step S105 in FIG. 3), and receives a notification of whether or not the handover is possible from the target base station (Step S106 in FIG. 3). In Step S106, in a case where a notification (for example, a handover request ACK) that the handover is approved is received, the data processing module 101-1 notifies the source base station of the target base station information through the backhaul line, and provides a handover instruction (Step S107 in FIG. 3).

The information data generation module 101-4 converts data (transmission data) that is transmitted from the macro cell base station 100 to the terminal 300 into a signal format that is determined in advance, and sets the resulting data to be downlink information data. At this point, the downlink information data includes data that is transferred from a Medium Access Control (MAC) layer to a physical layer, and includes parameters that are set in an RRC layer that controls such parameters. Furthermore, the information data generation module 101-4 outputs the downlink information data to the physical layer control module 102.

The physical layer control module 102 outputs the downlink information data, which is input from the information data generation module 101-4 to the coding module 103. Furthermore, based on the control information, which is input from the control information detection module 123, the physical layer control module 102 determines a pattern for generating a reference signal, and outputs the pattern for generating the reference signal to the reference signal generation module 105. Furthermore, the physical layer control module 102 outputs the control information, which is input from the control information detection module 123 to the control signal generation module 106.

The coding module 103 performs error correction encoding on the downlink information data, which is input from the physical layer control module 102. A coding scheme that is used by the coding module 103 when performing error correction encoding is, for example, turbo coding, convolutional coding, low density parity check coding (LDPC), or the like. Moreover, the coding module 103 may perform rate matching processing on a coded bit sequence in order to match a coding rate of a data sequence on which the error correction encoding is performed to a coding rate that corresponds to a data transfer rate. Furthermore, the coding module 103 may have a function of rearranging and interleaving the data sequence on which the error correction encoding is performed.

The modulation module 104 modulates a signal that is input from the coding module 103 and thus generates a modulation symbol. Modulation processing operations that are performed by the modulation module 104 are Binary Phase Shift Keying (BPSK), Quadrature Phase Shift Keying (QPSK), Quadrature Amplitude Modulation (QAM), and the like. Moreover, the modulation module 104 may have a function of rearranging and interleaving the generated modulation symbol.

The reference signal generation module 105 generates a reference signal (a pilot signal) from the pattern for generating the reference signal, which is input from the physical layer control module 102, and outputs the generated reference signal to the resource mapping module 108. At this point, the reference signal is used to estimate channel performance of an air link from the macro cell base station 100 to the terminal 300, to measure received quality of the air link from the macro cell base station 100 to the terminal 300, and to measure a distance of the terminal 300 from the macro cell base station 100, and the like.

The control signal generation module 106 generates a control signal from the control information, which is input from the physical layer control module 102. Moreover, the error correction encoding and the modulation processing may be performed on the control signal.

Based on the cell ID of the macro cell base station 100 itself, the synchronization signal generation module 107 generates the synchronization signal in accordance with a rule that is determined in advance in the system.

Based on resource allocation information generated in the control information generation module 106, the resource mapping module 108 maps the modulation symbol, the reference signal, the control signal, and the synchronization signal to resource elements (this is referred to as resource mapping).

The IFFT module 109 performs Inverse Fast Fourier Transform (IFFT) on a frequency-domain signal, which is input from the resource mapping module 108, and transforms the resulting signal into a time-domain signal. If the frequency-domain signal can be transformed into the time-domain signal, instead of IFFT, the IFFT module 109 may use a different processing scheme, for example, Inverse Discrete Fourier Transform (IDFT).

The CP insertion module 110 adds a cyclic prefix (CP) to the time-domain signal (which is referred to as a valid symbol), which is input from the IFFT module 109 and thus generates an OFDM symbol. The CP is a guard section that is added for the purpose of avoiding multi-pass interference that occurs due to a delay wave.

The transmission module 111 converts the OFDM symbol, which is input from the CP insertion module 110, from a digital signal to an analog-signal (performs digital to analog conversion (D/A conversion) on the OFDM symbol). Furthermore, the transmission module 111 band-limits the generated analog signal by the filtering processing, thus generates a band-limited signal, up-converts the generated band-limited signal into a radio frequency band, and transmits a result of the up-converting from the transmit antenna module 112.

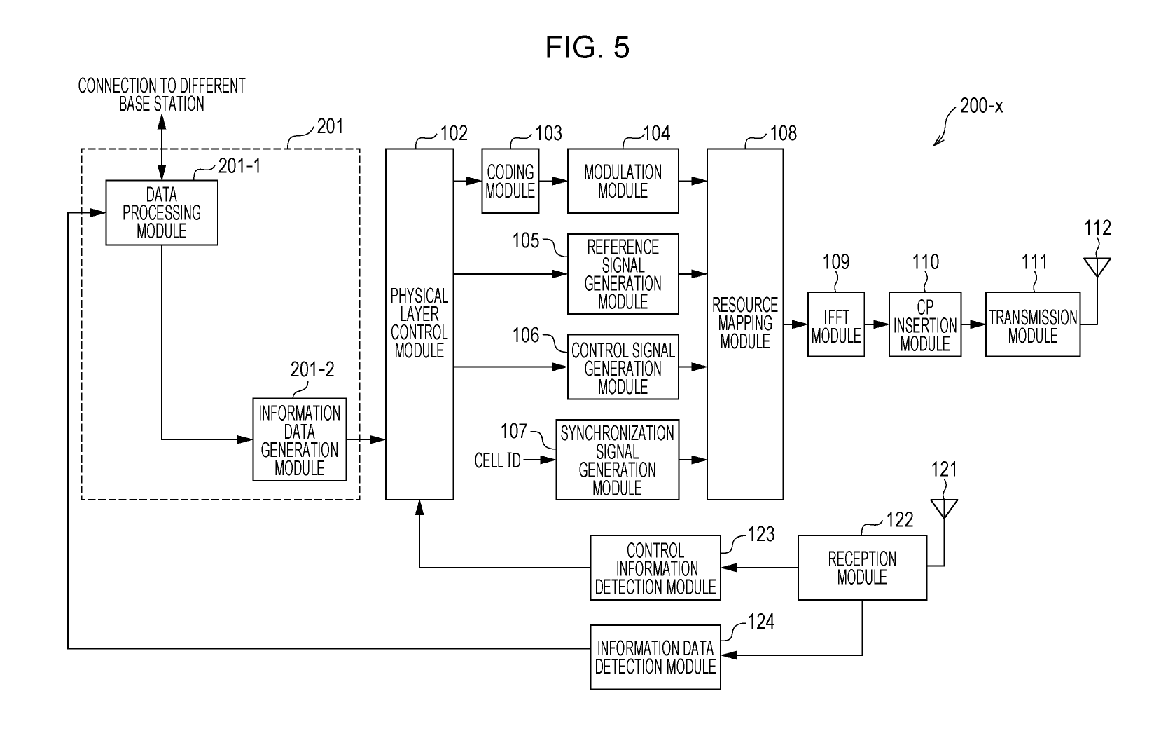

FIG. 5 is a schematic block diagram illustrating a configuration example of the low-power base station 200-x according to the first embodiment.

The low-power base station 200-x includes a data processing module 201-1, an information data generation module 201-2, the physical layer control module 102, the coding module 103, the modulation module 104, the reference signal generation module 105, the control signal generation module 106, the synchronization signal generation module 107, the resource mapping module 108, the IFFT module 109, the CP insertion module 110, the transmission module 111, the transmit antenna module 112, the receive antenna module 121, the reception module 122, the control information detection module 123, and the information data detection module 124. Moreover, the data processing module 201-1 and the information data generation module 201-2 are referred to as a higher layer 201. Furthermore, in a case where one portion of or all portions of the low-power base station 200-x described above are integrated into an integrated circuit, a chip control circuit (not illustrated) is provided that performs control on each functional block. Moreover, in FIG. 5, the number of transmit antennas and the number of receive antennas are set to 1, but multiple antennas may be provided.

According to the present embodiment, a difference between the low-power base station 200-x and the macro cell base station 100 lies in the higher layer. Only the higher layer 201 in FIG. 5 is described below, but processing operations that have the same reference numerals as those in FIG. 4 are the same as those in FIG. 4.

First, the low-power base station 200-4 (the target base station) is described.

The data processing module 201-1 receives the handover request from the macro cell base station 100 through the backhaul line (Step S105 in FIG. 3). Furthermore, the data processing module 201-1 determines whether or not the connection to the terminal 300 is possible, and notifies the macro cell base station 100 whether or not the handover is possible (S106 in FIG. 3). At this point, in a case where the connection is possible, the information data generation module 201-2 converts the data that is transmitted from the low-power base station 200-4 to the terminal 300 into the signal format that is determined in advance, and sets the resulting data to be the downlink information data.

Next, the low-power base station 200-2 (the source base station) is described.

The data processing module 201-1 receives a handover instruction from the macro cell base station 100 through the backhaul line (Step S107 in FIG. 3).

In Step S107, in a case where the handover instruction is received, the data processing module 201-1 detects the target base station information that is included in the handover instruction, and outputs the detected target base station information to the information data generation module 201-2. The information data generation module 201-2 converts the data and the target base station information that are transmitted from the low-power base station 200-2 to the terminal 300 into the signal format that is determined in advance, and sets the resulting data to be the downlink information data.

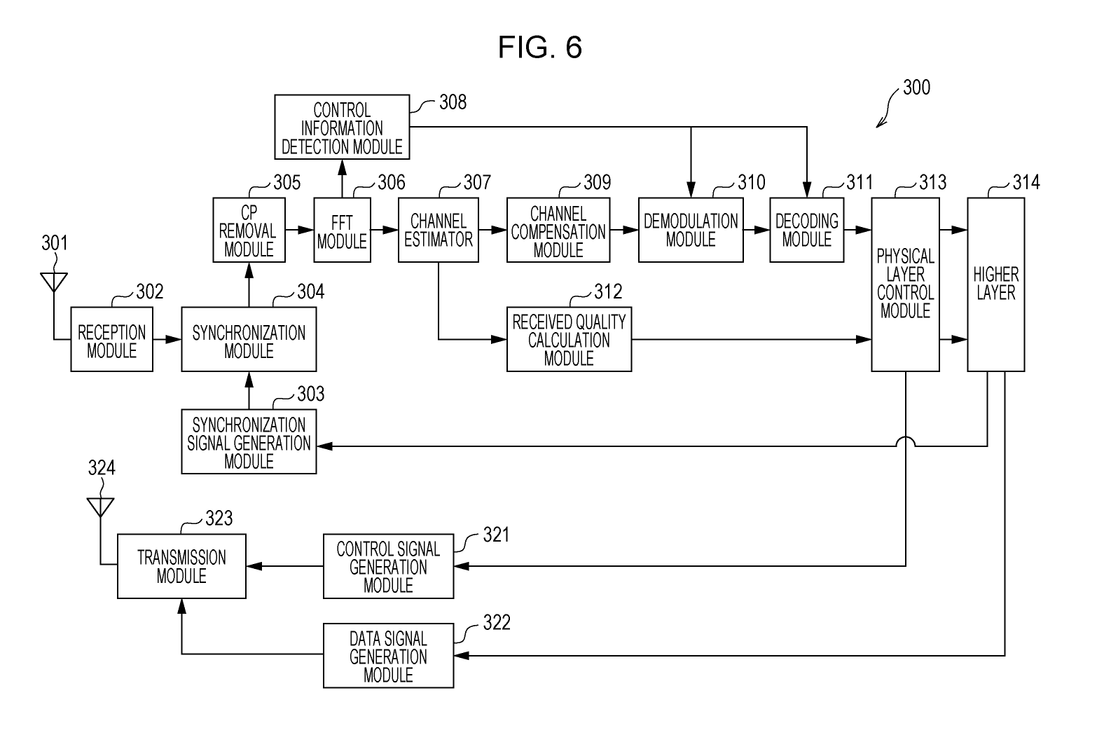

FIG. 6 is a schematic block diagram illustrating a configuration example of the terminal 300 according to the first embodiment.

The terminal 300 includes a receive antenna module 301, a reception module 302, a synchronization signal generation module 303, a synchronization module 304, a CP removal module 305, an FFT module 306, a channel estimator 307, a control information detection module 308, a channel compensation module 309, a demodulation module 310, a decoding module 311, a received quality calculation module 312, a physical layer control module 313, a higher layer 314, a control signal generation module 321, a data signal generation module 322, a transmission module 323, and a transmit antenna module 324. Furthermore, in a case where one portion of or all portions of the terminal 300 described above are integrated into an integrated circuit, a chip control circuit (not illustrated) is provided that performs control on each functional block. Moreover, in FIG. 5, the number of transmit antennas and the number of receive antennas are set to 1, but multiple antennas may be provided.

Through the receive antenna module 301, the terminal 300 receives a signal that is transmitted from the macro cell base station 100 and the low-power base station 200-x.

The reception module 302 down-converts a radio frequency signal, which is input from the receive antenna module 301 into a frequency band in which the digital signal processing is possible, and performs filtering processing. Additionally, the reception module 302 A/D-converts the signal on which the filtering processing is performed from an analog signal to a digital signal, and outputs the digital signal that results from the conversion to the synchronization module 304.

Moreover, in a case where a synchronization signal of the low-power base station 200-x is detected, the reception module 302 matches a radio frequency to a frequency that is allocated to the low-power base station 200-x, and thus detects a radio frequency signal.

In the synchronization signal generation module 303, a synchronization signal is generated which corresponds to the base station that performs the synchronization.

The synchronization module 304 performs the synchronization based on the signal, which is input from the reception module 302 and the signal, which is input from the synchronization signal generation module 303, and, in a case where the synchronization is completed, outputs the received signal to the CP removal module 305.

The CP removal module 305 removes a CP from a signal that is output from the reception module 302 in order to avoid distortion due to the delay wave, and outputs the signal from which the CP is removed to the FFT module 306.

The FFT module 306 performs Fast Fourier Transform (FFT) that transforms the signal, which is input from the CP removal module 305 from a time-domain signal to a frequency-domain signal, outputs the modulation symbol and the reference signal to the channel estimator 307, and outputs the control signal to the control information detection module 308. Moreover, if the signal can be transformed from the time domain to the frequency domain, the FFT module 306 may perform a different scheme, for example, Discrete Fourier Transform (DFT), without being limited to the FFT.

The channel estimator 307 demaps a reference signal (a reference signal for channel estimation), which is included in the signal, which is output by the FFT module 306, and performs the channel estimation using the reference signal. Furthermore, the channel estimator 307 outputs estimated channel information to the channel compensation module 309 and the received quality calculation module 312.

The control information detection module 308 performs detection of the control information that is included in the signal, which is output to the reception module 302. Furthermore, the control information detection module 308 extracts various pieces of information, such as resource block allocation information, MCS information, HARQ information, and TPC information, which are included in the control information. Then, the various pieces of information that are extracted are detected and are output to the demodulation module 310 and the decoding module 311.

Based on a channel estimate value, which is input from the channel estimator 307, the channel compensation module 309 calculates a weighting coefficient that compensates for channel distortion due to fading, using a scheme such as zero forcing (ZF) equalization or minimum mean square error (MMSE) equalization, and performs channel compensation on the modulation symbol, which is input.

The demodulation module 310 performs demodulation processing on the signal that goes through the channel compensation, which is input from the channel compensation module 309. The demodulation processing may be any one of hard decision (calculation of a coded bit sequence) and soft decision (calculation of a coded bit LLR).

The decoding module 311 performs error correction decoding processing on the post-demodulation coded bit sequence (or the post-demodulation coded bit LLR) that is output by the demodulation module 310, calculates the downlink information data, and outputs the downlink information data to the physical layer control module 313. At this time, the target base station information is included in information data decoded (Step S109 in FIG. 3). Such an error correction decoding processing scheme is a scheme that corresponds to error correction encoding, such as the turbo coding or the convolutional coding, which is performed by the base station, the connection to which is made. The error correction decoding processing can be applied to any one of the hard decision and the soft decision. Moreover, in a case where the base station transmits an interleaved data modulation symbol, the decoding module 311 performs deinterleaving processing corresponding to the interleaving on the coded bit sequence, which is input, before performing the error correction decoding processing. Then, the decoding module 311 performs the error correction decoding processing on the signal on which the deinterleaving processing is performed.

Based on the channel information, which is input from the channel estimator 307, the received quality calculation module 312 calculates the received quality and outputs the received quality to the physical layer control module 313.

The physical layer control module 313 outputs the downlink information data (the target base station information and the like) and the received quality that are input, to the higher layer 314. Furthermore, the physical layer control module 313 generates the control information from the received quality, and outputs the generated control information to the control signal generation module 321.

The higher layer 314 sets data that is transmitted to each base station to be the uplink information data, and outputs the uplink information data to the data signal generation module 322. At this point, in a case where the received quality is notified to the base station, the received quality is included in the uplink information data. Moreover, the received quality that is included in the uplink information data, desirably, is received quality that is measured over a long period of time, and may be newly generated in the higher layer 314 based on the received quality that is calculated in the received quality calculation module 312. Furthermore, the higher layer 314 outputs the target base station information to the synchronization signal generation module 303.

The control signal generation module 321 performs the error correction encoding and the modulation mapping on the control information, which is input, and generates the control signal.

The data signal generation module 322 performs the error correction encoding and the modulation mapping on the uplink information data, which is input, and generates the uplink data signal.

In the transmission module 323, the signal that includes the control signal, which is input from the control signal generation module 321 and the uplink data signal, which is input from the data signal generation module 322 is D/A-converted, is up-converted into the frequency band in which the transmission is possible in the uplink, and, through the transmit antenna module 324, is transmitted to the base station in a cell, the connection to which is made.

Based on the target base station information, which is input, the synchronization signal generation module 303 generates a synchronization signal and outputs the generated synchronization signal to the synchronization module 304 (Step S110 in FIG. 3). Accordingly, in the next reception processing, the signal from the base station that is indicated in the target base station information can be made to be detected (Step S111 in FIG. 3), and the connection to the target base station is completed (Step S112 in FIG. 3).

According to the present embodiment, the macro cell base station determines whether or not the terminal that makes a connection to the low-power base station has to perform the handover, and the macro cell base station uses a handover procedure. Thus, an amount of processing relating to the handover in the low-power base station can be decreased and the connection destination can be efficiently switched.

### Second Embodiment

According to the first embodiment, a method is provided in which the macro cell base station 100 notifies the terminal 300 of the handover instruction through the source base station, but according to the present embodiment, the macro cell base station 100 notifies the terminal 300 of the handover instruction.

Configurations of the communication system, the low-power base station 200-x and the terminal 300 according to the present embodiment are the same as those according to the first embodiment. Differences from the first embodiment will mainly be described below.

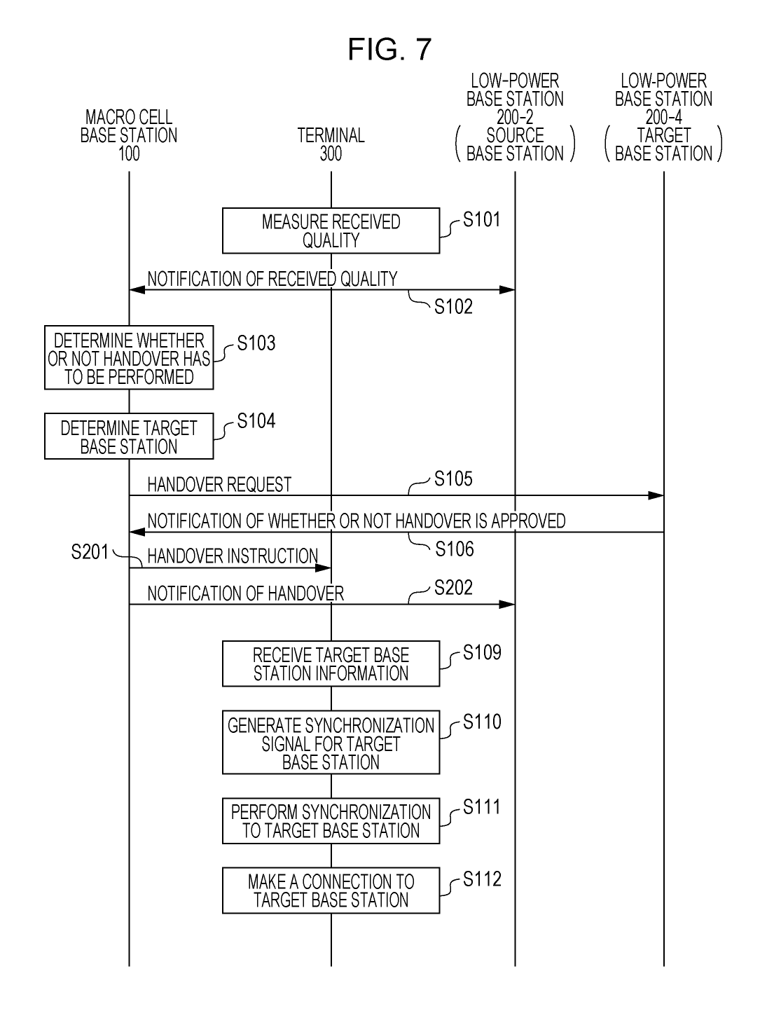

FIG. 7 is a sequence diagram illustrating one example of a flow of processing operations that are performed by a communication system according to the second embodiment. According to the first embodiment, the macro cell base station 100 provides the handover instruction to the terminal through the source base station (Steps S107 and S108 in FIG. 3). However, according to the present embodiment, the macro cell base station 100 directly provides the handover instruction to the terminal (Step S201 in FIG. 7). Furthermore, the macro cell base station 100 transmits handover notification to the source base station in order to notify the source base station that the connection destination of the terminal 300 has changed (Step S202 in FIG. 7).

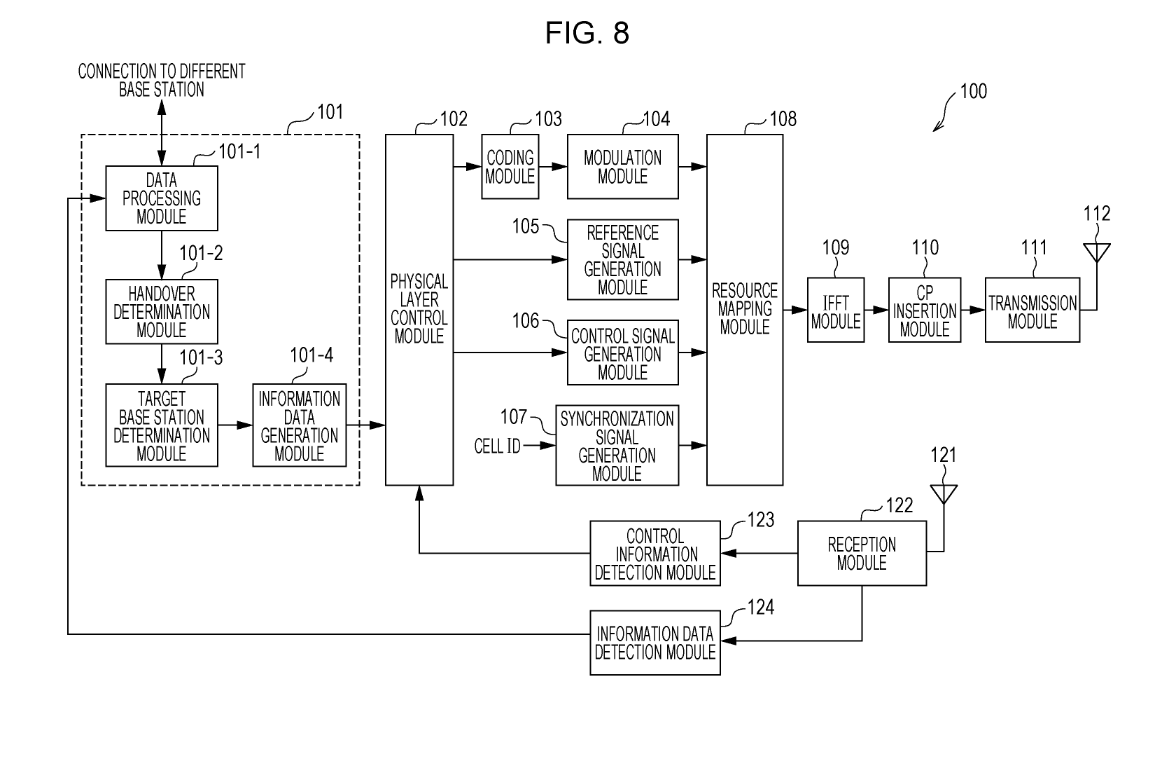

FIG. 8 is a schematic block diagram illustrating a configuration example of a macro cell base station 100 according to the second embodiment. A difference from the macro base station (in FIG. 4) according to the first embodiment is that the target base station determination module 101-3 outputs the target base station information to the information data generation module 101-4 in FIG. 8. Therefore, according to the present embodiment, the downlink information data that is generated in the information data generation module 101-4 is information that includes the target base station information, and the macro cell base station 100 transmits the target base station information to the terminal 300.

According to the present embodiment, the macro cell base station determines whether or not the terminal that make a connection to the low-power base station has to perform the handover, and the macro cell base station provides the handover instruction to the terminal. Thus, an amount of processing relating to the handover in the low-power base station can be decreased and the connection destination can be efficiently switched.

### Third Embodiment

According to the first embodiment and the second embodiment, the macro cell base station 100 determines whether or not the terminal 300 has to perform the handover, but according to the present embodiment, the source base station determines whether or not the terminal 300 performs the handover.

Configurations of the communication system and the terminal 300 according to the present embodiment are the same as those according to the first embodiment. Differences from the first embodiment mainly will be described below.

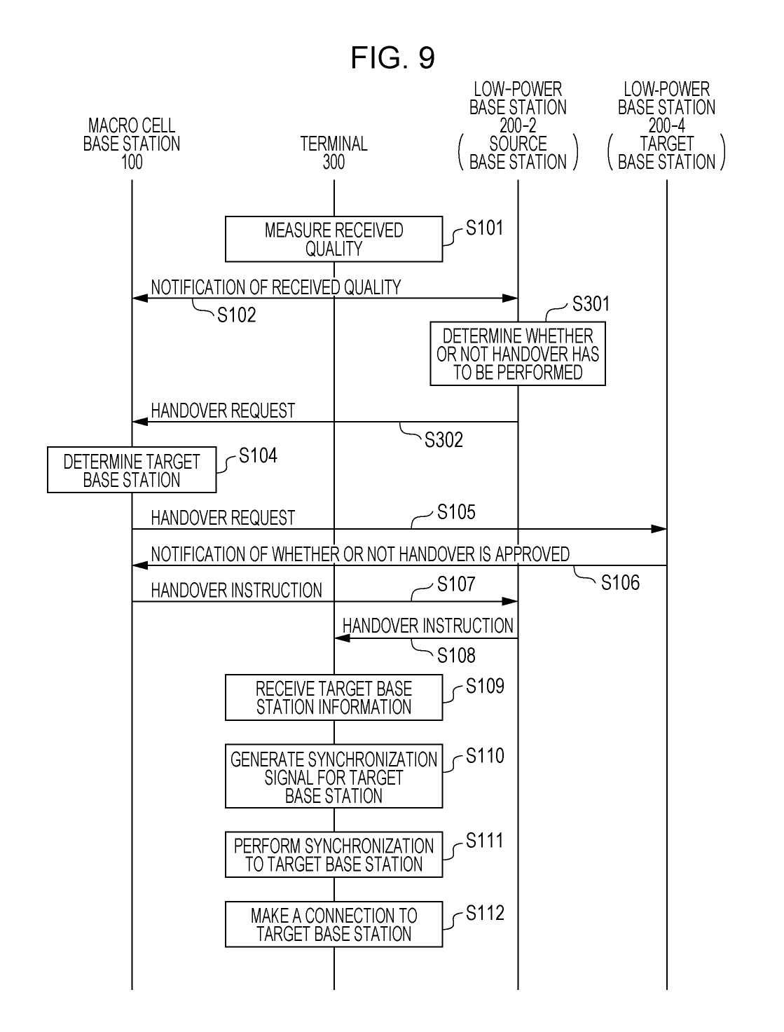

FIG. 9 is a sequence diagram illustrating one example of a flow of processing operations that are performed by a communication system according to the third embodiment. According to the first embodiment, based on the received quality notified from the terminal 300, the macro cell base station 100 determines whether or not the terminal 300 has to perform the handover (Step S103 in FIG. 3). However, according to the present embodiment, based on the received quality notified from the terminal 300, the source base station determines whether or not the terminal 300 has to perform the handover (S301 in FIG. 9), and in a case where the source base station determines that the handover has to be performed, the source base station notifies the macro cell base station of the handover request (the first handover request) (Step S302).

Moreover, Step S102 according to the present embodiment is the same as that according to the first embodiment. In Step S102, if the terminal 300 notifies the macro cell base station of the received quality of each of the neighboring base station and the source base station, this may be the handover notification. Furthermore, if the terminal 300 notifies the source base station of only the received quality of the base station (the source base station) to which the terminal 300 itself makes a connection, this may be satisfactory. Furthermore, if the terminal 300 notifies the source base station of the received quality of the neighboring base station, this may be satisfactory.

In Step S301, in a case where the received quality notified from the terminal 300 is only the received quality of the source base station, for example, the source base station can set a threshold in advance, and in a case where the received quality of the source base station falls below the threshold, the source base station can determine that the terminal 300 has to perform the handover. On the other hand, in a case where the received quality of the source base station exceeds the threshold, the macro cell base station 100 can determine that the terminal 300 does not have to perform the handover. Furthermore, in the case where the received quality notified from the terminal 300 is the received quality of each of the neighboring base station and the source base station, for example, the source base station can compare the received quality of the neighboring base station and the received quality of the source base station, and, if there is a base station that has better received quality than the source base station is present, the source base station can determine that the handover has to be performed.

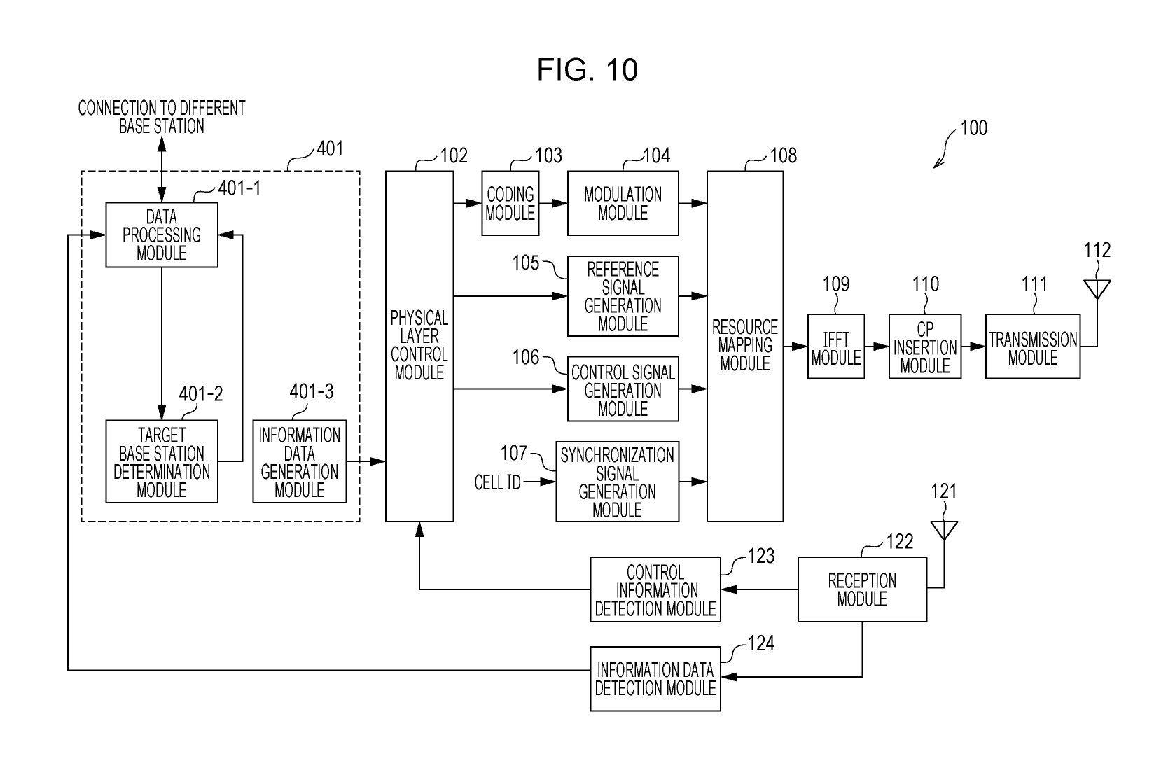

FIG. 10 is a schematic block diagram illustrating a configuration example of a macro cell base station 100 according to the third embodiment. The macro cell base station 100 according to the third embodiment is different from the macro base station (FIG. 4) according to the first embodiment in terms of a configuration of a higher layer 401. The higher layer 401 is configured from a data processing module 401-1, a target base station determination module 401-2, and an information data generation module 401-3.

The data processing module 401-1 performs processing of data that is acquired by the higher layer 401. The data processing module 401-1 detects the received quality from the uplink information data. Furthermore, the data processing module 401-1 receives the handover request from the source base station through the backhaul line (Step S302 in FIG. 9). In a case where the handover request is received, the data processing module 401-1 outputs the received quality to the target base station determination module 401-2.

Based on the received quality, which is input from the data processing module 401-1, the target base station determination module 401-2 determines the target base station (Step S104 in FIG. 9), and outputs the target base station information to the data processing module 401-1.

Through the backhaul line, the data processing module 401-1 notifies the target base station of the handover request (Step S105 in FIG. 9), and receives the notification of whether or not the handover is possible from the target base station (Step S106 in FIG. 9). In Step S106, in the case where the notification that the handover is approved is received, the data processing module 401-1 notifies the source base station of the target base station information through the backhaul line, and provides the handover instruction (Step S107 in FIG. 9).

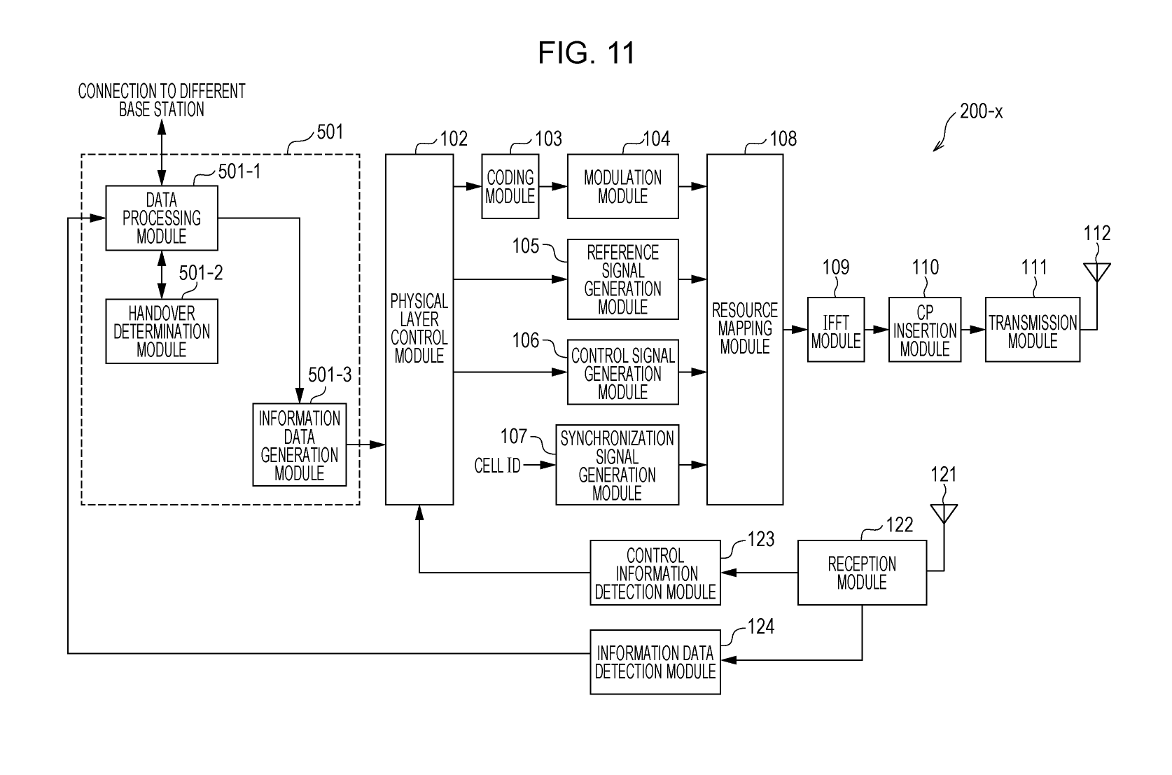

FIG. 11 is a schematic block diagram illustrating a configuration example of a low-power base station 200-x according to the third embodiment. The low-power base station according to the third embodiment is different from the low-power base station (FIG. 5) according to the first embodiment in terms of a configuration of a higher layer 501. The higher layer 501 is configured from a data processing module 501-1, a handover determination module 501-2, and an information data generation module 501-3.

In the source base station, the data processing module 501-1 outputs the received quality to the handover determination module 501-2, and based on the received quality, which is input from the data processing module 501-1, the handover determination module 501-2 determines whether or not the terminal 300 has to perform the handover (Step S301 in FIG. 9). In Step S301 in FIG. 9, in a case where it is determined that the handover has to be performed, the data processing module 501-1 notifies the macro cell base station 100 of the handover request through the backhaul line (Step S302 in FIG. 9). Furthermore, in Step S107 in FIG. 9, in a case where the handover instruction is received from the macro cell base station 100, the data processing module 501-1 outputs the target base station information that is included in the handover instruction to the information data generation module 501-3, and the information data generation module 501-3 sets the target base station information to be the downlink information data (Step S108 in FIG. 9).

According to the present embodiment, the source base station determines whether or not the terminal that make a connection to the low-power base station has to perform the handover, and the macro cell base station provides the handover instruction to the target base station. Thus, an amount of processing relating to the handover in the low-power base station can be decreased and the connection destination can be efficiently switched.

### Fourth Embodiment

According to the third embodiment, a method is provided in which, in a case where the source base station determines whether or not the terminal that makes a connection to the low-power base station has to perform the handover, the macro cell base station 100 provides the handover instruction to the terminal 300 through the source base station, but according to the present embodiment, the macro cell base station 100 instructs the terminal 300 to perform the handover.

Configurations of the communication system, the low-power base station 200-x and the terminal 300 according to the present embodiment are the same as those according to the third embodiment. Differences from the third embodiment will mainly be described below.

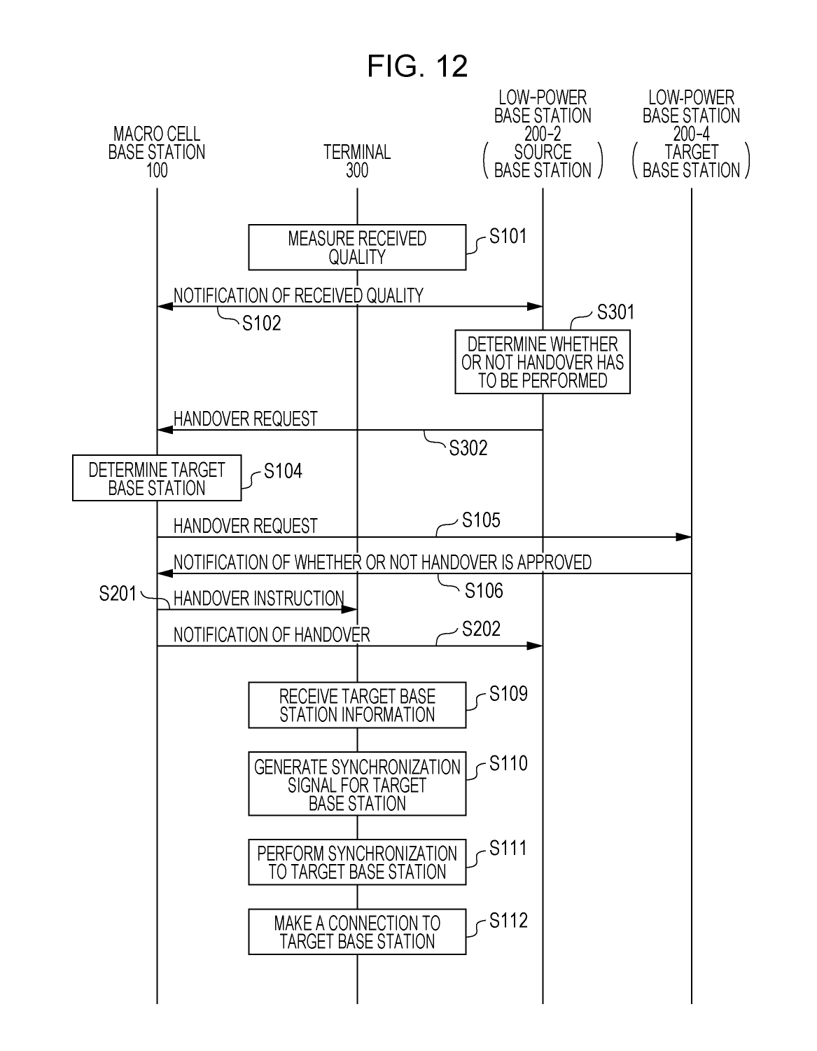

FIG. 12 is a sequence diagram illustrating one example of a flow of processing operations that are performed by a communication system according to the fourth embodiment. According to the third embodiment, the macro cell base station 100 provides the handover instruction to the terminal through the source base station (Steps S107 and S108 in FIG. 9). However, according to the present embodiment, the macro cell base station 100 directly provides the handover instruction to the terminal (Step S201 in FIG. 12).

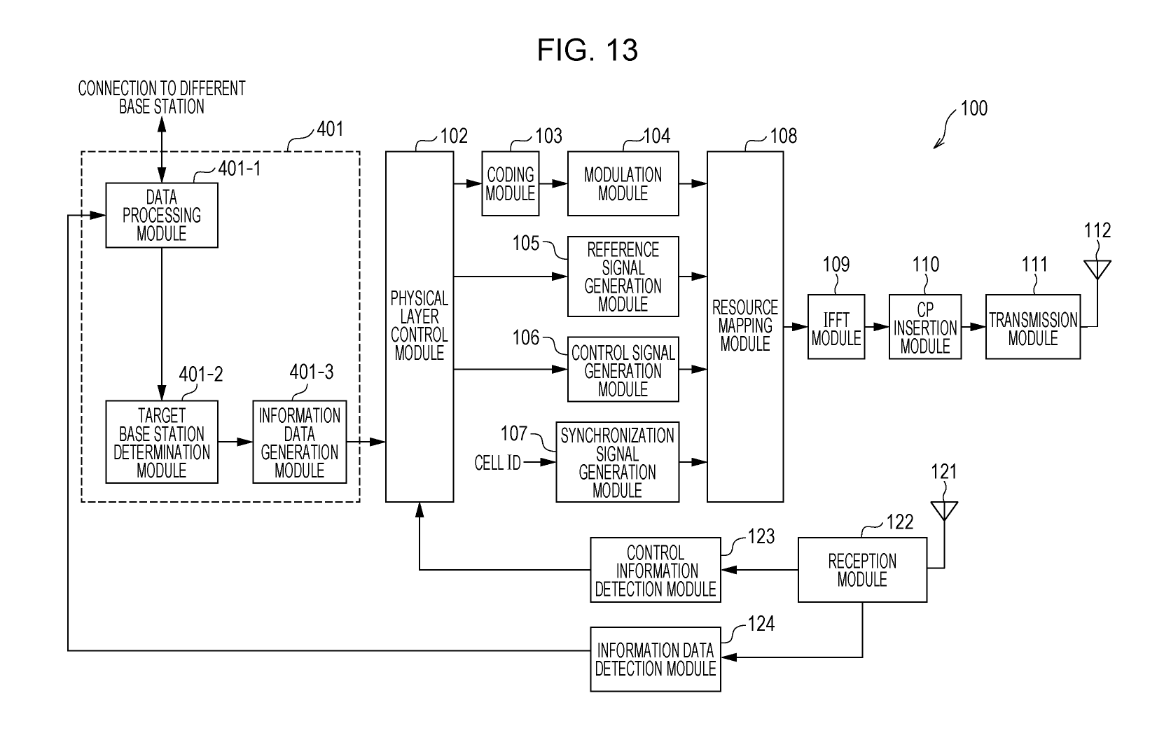

FIG. 13 is a schematic block diagram illustrating a configuration example of a macro cell base station 100 according to the fourth embodiment. Differences from the macro base station (FIG. 10) according to the third embodiment are that the target base station determination module 401-2 outputs the target base station information to the information data generation module 401-3 in FIG. 13. Therefore, according to the present embodiment, the downlink information data that is generated in the information data generation module 401-3 is information that includes the target base station information, and the macro cell base station 100 transmits the target base station information to the terminal 300.

According to the present embodiment, the source base station determines whether or not the terminal that makes a connection to the low-power base station has to perform the handover, and the macro cell base station provides the handover instruction to the terminal. Thus, an amount of processing relating to the handover in the low-power base station can be decreased and the connection destination can be efficiently switched.

Furthermore, according to the embodiments of the present invention, which are described above, a handover inquiry may be substituted for the handover request. The handover inquiry is one example of the handover request. For example, a first handover inquiry includes a first handover request for changing a connection destination of the terminal and information needed for changing the connection destination of the terminal. Furthermore, a second handover inquiry includes a second handover request for a connection by the terminal and information needed for the connection by the terminal. The information needed for changing the connection destination of the terminal is information relating to the terminal, such as information for specifying a terminal that is a target for the handover or information indicating performance of the terminal.

A program running on the base station and the terminal according to the present invention is a program (a program for causing a computer to operate) that controls a CPU and the like in such a manner as to realize the functions according to the described-above embodiments of the present invention. Then, pieces of information that are handled in these apparatuses are temporarily stored in a RAM while being processed. Thereafter, the pieces of information are stored in various ROMs or HDDs, and as needed, are read by the CPU to be modified or written. As a recording medium on which to store the program, among a semiconductor medium (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the functions according to the embodiments described above are realized by running the loaded program, and in addition, the functions according to the present invention are realized in conjunction with an operating system or other application programs, based on an instruction from the program.

Furthermore, in a case where a programs distributed on the market, the program stored on a portable recording medium can be distributed or the program can be transmitted to a server computer that connects through a network such as the Internet. In this case, a storage device in the server computer also is included in the present invention. Furthermore, some or all of the portions of the base station and the terminal according to the embodiments described above may be realized as an LSI that is a typical integrated circuit. Each functional block of the base station and the terminal may be individually built into a chip, and some or all functional blocks may be integrated into a chip. Furthermore, a circuit integration technique is not limited to an LSI, and an integrated circuit for a functional block may be realized with a dedicated circuit or a general-purpose processor. In a case where each functional block is integrated into a circuit, an integrated circuit control module is added that controls these functional blocks.

Furthermore, a circuit integration technique is not limited to an LSI, and an integrated circuit for a functional block may be realized with a dedicated circuit or a general-purpose processor. Furthermore, if with advances in a semiconductor technology, a circuit integration technology with which an LSI is replaced appears, it is also possible to use an integrated circuit to which such a technology is applied.

Furthermore, the invention in the present application is not limited to the embodiments described above. Furthermore, application of the terminal according to the invention in the present application is not limited to mobile station devices. It goes without saying that the terminal can be applied to a stationary-type electronic apparatus that is installed indoors or outdoors, or a non-movable-type electronic apparatus, for example, an AV apparatus, a kitchen apparatus, a cleaning or washing machine, an air-conditioning apparatus, office equipment, a vending machine, and other household apparatuses.

The embodiments of the invention are described in detail above referring to the drawings, but the specific configuration is not limited to the embodiments and includes an amendment to a design that falls within a scope that does not depart from the gist of the present invention. Furthermore, various modifications are possible within the scope of the present invention defined by claims, and embodiments that are made by suitably combining technical means disclosed according to the different embodiments are also included in the technical scope of the present invention. Furthermore, a configuration in which a constituent element that achieves the same effect is substituted for the constituent element that is described according to each of the embodiments is also included in the technical scope of the present invention.

### INDUSTRIAL APPLICABILITY

The present invention is suitably used for a base station and a terminal.

### REFERENCE SIGNS LIST

10 MACRO CELL
100 MACRO CELL BASE STATION
20-1, 20-2, 20-3, 20-4 SMALL CELL
200-1, 200-2, 200-3, 200-4 LOW-POWER BASE STATION
300 TERMINAL
101, 201, 401, 501 HIGHER LAYER
101-1, 201-1, 401-1, 501-1 DATA PROCESSING MODULE
101-2, 501-2 HANDOVER DETERMINATION MODULE
101-3, 401-2 TARGET BASE STATION DETERMINATION MODULE
101-4, 201-2, 401-3, 501-3 INFORMATION DATA GENERATION MODULE
102 PHYSICAL LAYER CONTROL MODULE
103 CODING MODULE
104 MODULATION MODULE
105 REFERENCE SIGNAL GENERATION MODULE
106 CONTROL SIGNAL GENERATION MODULE
107 SYNCHRONIZATION SIGNAL GENERATION MODULE
108 RESOURCE MAPPING MODULE
109 IFFT MODULE
110 CP INSERTION MODULE
111 TRANSMISSION MODULE
112 TRANSMIT ANTENNA MODULE
121 RECEIVE ANTENNA MODULE
122 RECEPTION UNIT
123 CONTROL INFORMATION DETECTION MODULE
124 INFORMATION DATA DETECTION MODULE
301 RECEIVE ANTENNA MODULE
302 RECEPTION MODULE
303 SYNCHRONIZATION SIGNAL GENERATION MODULE
304 SYNCHRONIZATION MODULE
305 CP REMOVAL MODULE
306 FFT MODULE
307 CHANNEL ESTIMATOR
308 CONTROL INFORMATION DETECTION MODULE
309 CHANNEL COMPENSATION MODULE
310 DEMODULATION MODULE
311 DECODING MODULE
312 RECEIVED QUALITY CALCULATION MODULE
313 PHYSICAL LAYER CONTROL MODULE
314 HIGHER LAYER
321 CONTROL SIGNAL GENERATION MODULE
322 DATA SIGNAL GENERATION MODULE
323 TRANSMISSION MODULE
324 TRANSMIT ANTENNA MODULE

1. A first base station in a communication system that includes the first base station, a second base station, and at least one terminal that makes a connection to the second base station,
wherein information that relates to received quality of the terminal with respect to each of the second base station and a neighboring base station that is positioned in the neighborhood of the second base station is received from the terminal.

2. The first base station according to claim 1,
wherein, in a case where a first handover request for changing a connection destination of the terminal is present, based on the received quality, a third base station that is a new connection destination of the terminal is determined.

3. The first base station according to claim 2,
wherein the first handover request is made based on the received quality.

4. The first base station according to claim 2,
wherein the first handover request is notified from the second base station.

5. The first base station according to claim 4,
wherein the first handover request is a first handover inquiry that includes information needed for changing the connection destination of the terminal.

6. The first base station according to claim 2,
wherein the third base station is notified of a second handover request for a connection by the terminal.

7. The first base station according to claim 6,
wherein a response to the second handover request is received from the third base station.

8. The first base station according to claim 7,
wherein, in a case where the response to the second handover request is an ACK, the terminal is instructed to make a connection to the third base station, and the terminal is notified of target base station information that is information on the third base station.

9. The first base station according to claim 7,
wherein in the case where the response to the second handover request is an ACK, the second base station is instructed to allow the terminal to make a connection to the third base station.

10. The first base station according to claim 9,
wherein the second handover request is a second handover inquiry that includes information needed for the connection by the terminal.

11. A second base station in a communication system that includes a first base station, the second base station, and at least one terminal that makes a connection to the second base station,
wherein it is determined whether or not a connection destination of the terminal has to be changed, and in a case where it is determined that the connection destination has to be changed, the first base station is notified of a first handover request.

12. The second base station according to claim 11,
wherein the first handover request is a first handover inquiry that includes information needed for changing the connection destination of the terminal.

13. The second base station according to claim 11,
wherein the second base station receives a notification that the terminal makes a connection to the third base station from the first base station, notifies the terminal of an instruction to make a connection to the third base station, and notifies the terminal of information on the third base station.

14. A terminal in a communication system that includes a first base station, a second base station, and at least one terminal that makes a connection to the second base station,
wherein the first base station is notified of information relating to received quality of the terminal with respect to each of the second base station and a neighboring base station that is positioned in the neighborhood of the second base station.

15. The terminal according to claim 14,
wherein information on a third base station that is a new connection destination is received from at least one of the first base station and the second base station, and communication with the third base station is started using the information on the third base station.
